(19) United States
(12) Patent Application Publication
(10) Pub. No.: US 2016/0363763 A1
(43) Pub. Date: Dec. 15, 2016

(54) HUMAN FACTOR-BASED WEARABLE DISPLAY APPARATUS

(71) Applicant: ELECTRONICS AND TELECOMMUNICATIONS RESEARCH INSTITUTE, Daejeon (KR)

(72) Inventors: Ung-Yeon YANG, Daejeon (KR); Ki-Hong KIM, Sejong (KR); Jin-Ho KIM, Daejeon (KR)

(21) Appl. No.: 15/006,851

(22) Filed: Jan. 26, 2016

(30) Foreign Application Priority Data
Jun. 15, 2015 (KR) 10-2015-0084306

(51) Int. Cl. G02B 27/00; G02B 27/01; G06T 19/00

(52) U.S. Cl. CPC G02B 27/0093; G06T 19/006; G02B 27/0176; G02B 27/0101; G02B 27/0179; G02B 2027/014; G02B 2027/0154; G02B 2027/0134; G02B 2027/0187

(57) ABSTRACT

An ideal wearable display apparatus, optimized based on human factors, includes: a user information tracking part for obtaining characteristic information of a user who wears the wearable display apparatus; a hardware module part, which includes a mechanism control module part for changing the spatial arrangement position and posture of a mechanism part of the wearable display apparatus; a software module part for simulating and generating virtual environment information based on static hardware parameters, input image data, and the information of the user information tracking part and mechanism control module part; and a human factor module part for correcting the difference between a simulation model in the software module part and a model recognized through the actual use of the apparatus.

### CROSS REFERENCE TO RELATED APPLICATION

This application claims the benefit of Korean Patent Application No. 10-2015-0084306, filed Jun. 15, 2015, which is hereby incorporated by reference in its entirety into this application.

### BACKGROUND OF THE INVENTION

1. Technical Field

The present invention relates generally to a human factor-based wearable display apparatus and, more particularly, to a human factor-based wearable display apparatus that belongs to a virtual reality technology and an augmented reality technology, which are commonly called mixed reality technology.

2. Description of the Related Art

The present invention belongs to a virtual reality technology and an augmented reality technology, which are commonly called mixed reality technology. Because the description of these technologies may be found in Wikipedia and the like, such a description will be omitted from the disclosure of the present invention.

Technical features that enable humans to experience mixed information, which is presented as multi-modal stimuli including images, sounds, and the like by being simulated in real time in the real world and computers, may be included in the related art.

Various visual factors affect the process whereby humans recognize an object as a 3D stereoscopic image. Typical factors are as follows. Because a human has left and right eyes, binocular disparity information is generated in the images observed from the external world, and this information is recognized as a single 3D stereoscopic image in the human brain. The principle of recognition of 3-dimensions based on the binocular disparity has been applied to a 3D stereoscopic image display apparatus, which is widely popularized. Such a display apparatus outputs images to be input to respective eyes of a user, and the user may view 3D image content by wearing an apparatus (for example, 3D stereoscopic glasses) that separates left and right images corresponding to the left and right eyes (refer to http://en.wikipedia.org/wiki/Binocular_disparity).

As a wearable display technology, there are a Head Mounted Display (HMD), a Face Mounted Display (FMD), a Head-Up Display (HUD), a Near-Eye Display (NED), an Eye Glasses-type Display (EGD), and the like. Devices for providing virtual information generated by computers to the ocular organs of a user may be broadly categorized into devices that use a see-closed method, in which the vision of a user is shut off from the outside, and devices that use a see-through method, which enables a user to see both the virtual information and the outside space.

The see-through method may be categorized into an optical see-through method, in which a user views the outside space through a transmissive/reflective optical module, and a vision-based see-through method, in which information obtained through image obtaining devices such as cameras is processed and is then presented to the user.

In order to provide a user with a virtual content experience, the virtual reality, augmented reality, and mixed reality technologies use a wearable display apparatus as a representative interface for presenting personalized immersive content.

Around the year 2010, Hollywood movies to which 3D visualization technology is applied and the supply of 3D TVs in the appliance market have raised general consumers' interest in 3D stereoscopic content. However, due to technological limitations, it is impossible to perfectly realize natural phenomena in visually recognized 3D stereoscopic space. Additionally, reports about adverse effects during the use of the technology are becoming more frequent, and research with the goal of solving the problems based on human factor-related issues in this industrial field is ongoing (refer to http://www.3dathome.org/webpage.aspx?webpage=2455).

Currently, 3D display technology has limitations that prevent the presentation of a perfect 3D stereoscopic image like the holographic displays that have been idealized in movies and novels, and is only able to approach this level of perfection.

Ordinary people, who have difficulty in accurately understanding technology, have high expectations for the experience of new technology when it is released, and may thus develop a negative opinion of commercialized high-end technology after they have experienced imperfect 3D technology.

In order to enable end users to be satisfied with the experience of new services based on virtual reality, augmented reality, and mixed reality technologies, it is necessary at the planning (imagination) step to optimize the technologies in three aspects, namely hardware, software, and human factors.

In terms of hardware concerning a wearable display apparatus, not only are the function and quality of individual components important, but the configuration and operation of these components must be closely connected to parameters presented in the process in which a human recognizes objects in a 3D stereoscopic view and the sense of space. In other words, an existing technology that may simply output a binocular image is insufficient to realize a high quality wearable display apparatus.

In terms of software concerning a wearable display apparatus, it is necessary to develop a technology capable of accepting hardware design specifications, making a virtual model of the process whereby a human recognizes a 3D stereoscopic image and the sense of depth and space, and outputting 3-dimensional data of a computer-simulated space to the hardware of 2D and 3D display apparatus. That is, because existing technology uses a stereoscopic image camera model that only handles binocular disparity information, it is impossible to present images optimized for individuals.

In terms of human factors concerning a wearable display apparatus, it is necessary to consider the capability of hardware and software to represent 3-dimensional stereoscopic images based on the way in which humans recognize 3-dimensional stereoscopic images. Also required is a technique in which the differences between a 3D image provided by the wearable display apparatus and an actual image recognized by a user are compensated for by applying a method for sampling responses to standard stimuli.

As a conventional art related to the present invention, there are Korean Patent Application Publication No 2008-0010502 (Face mounted display apparatus and method for mixed reality environment) and Korean Patent Application Publication No. 2002-0016029 (Head mounted display apparatus for video transmission by light fiber).

### SUMMARY OF THE INVENTION

Accordingly, the present invention has been made keeping in mind the above problems occurring in the conventional art, and an object of the present invention is to provide a wearable display apparatus that is optimized based on human factors.

In order to accomplish the above object, a human factor-based wearable display apparatus according to a preferred embodiment of the present invention includes: a hardware module part comprising a user information tracking part for obtaining characteristic information of a user who wears the wearable display apparatus; a software module part for simulating and generating virtual environment information based on static hardware parameters, input image data, and the information of the user information tracking part; and a human factor module part for correcting a difference between a simulation model in the software module part and a model recognized through actual use of the apparatus.

The hardware module part may further comprise a mechanism control module part for changing a spatial arrangement position and posture of a mechanism part of the wearable display apparatus, and the software module part may simulate the virtual environment information based on information of the mechanism control module part.

The characteristic information of the user may include information about a relative position and posture information of both eyeballs of the user.

The information about the relative position may be an inter pupil distance of the user.

The posture information may include a view vector.

The user information tracking part may comprise multiple image sensors and multiple EOG sensors.

The user information tracking part may perform learning by patterning a relationship between a standard input sample depending on movement of eyeballs and values obtained from the multiple image sensors and multiple EOG sensors, and may perform user information tracking based on the values obtained from the multiple image sensors and multiple EOG sensors.

The multiple image sensors may be disposed at a periphery in the mechanism part, the periphery being opposite to eyeballs of a user.

The multiple EOG sensors may be disposed in the mechanism part so as to contact a user's skin on a nose and between a temple and an ear.

The multiple image sensors are manufactured based on a principle of a micro-endoscope, and may be disposed at a periphery in the mechanism part, the periphery being opposite to eyeballs of a user.

The software module part may record optimized hardware configuration state information along with personal information of the user and may apply the information to optimize the hardware module part.

The hardware module part may further comprise an optical module part having a variable focus function.

The hardware module part may further comprise an image output module part for outputting an input image to the optical module part.

The hardware module part may further comprise an image synthesis control module part for transmitting input image data to the image output module part, based on the information from the user information tracking part.

The human factor module part may store a human recognition characteristic related to information presented by the wearable display apparatus.

The human recognition characteristic may comprise one or more human factors for recognizing a 3D image.

Also, a human factor-based wearable display apparatus according to a preferred embodiment of the present invention includes: a hardware module part comprising a mechanism control module part for changing a spatial arrangement position and posture of a mechanism part of the wearable display apparatus; a software module part for simulating and generating virtual environment information based on static hardware parameters, input image data, and the information of the user information tracking part; and a human factor module part for correcting a difference between a simulation model in the software module part and a model recognized through actual use of the apparatus.

The mechanism control module part may change 6 degrees of freedom of the mechanism part of the wearable display apparatus based on a value obtained from a user information tracking part.

The hardware module part may further comprise an optical module part having a variable focus function.

The hardware module part may further comprise an image output module part for outputting an input image to the optical module part.

Also, a user information tracking device of a wearable display apparatus according to a preferred embodiment of the present invention includes multiple image sensors and multiple EOG sensors.

The image sensors and the EOG sensors may be used for patterning and learning a relationship of standard input samples depending on movement of eyeballs, and for tracking user information.

The image sensors may be disposed at a periphery in a mechanism part of the wearable display apparatus, the periphery being opposite to eyeballs of a user.

The EOG sensors may be disposed in a mechanism part of the wearable display apparatus so as to contact a user's skin on a nose and between a temple and an ear.

The image sensors are manufactured based on a principle of a micro-endoscope, and may be disposed at a periphery in a mechanism part of the wearable display apparatus, the periphery being opposite to eyeballs of a user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a human factor-based wearable display apparatus according to an embodiment of the present invention;

FIGS. 2A and 2B illustrate an embodiment of a mechanism control module part and a user information tracking part, illustrated in FIG. 1;

FIGS. 3A, 3B, and 3C illustrate an example in which 6 degrees of freedom of a binocular module are changed by the mechanism control module part illustrated in FIG. 1;

FIG. 4 illustrates an example in which the convergence of a binocular module is changed by the mechanism control module part illustrated in FIG. 1;

FIG. 5 illustrates an example in which the focus of a binocular module is changed by the mechanism control module part illustrated in FIG. 1;

FIGS. 6A, 6B, and 6C illustrate an example in which an image sensor is differently installed;

FIGS. 7A and 7B illustrate an example in which an EOG sensor is differently installed; and

FIG. 8 is a view for explaining the user information extraction operation of the user information tracking part illustrated in FIG. 1.

### DESCRIPTION OF THE PREFERRED EMBODIMENTS

The present invention may be variously changed, and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as having ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings, and repeated descriptions of the same components will be omitted.

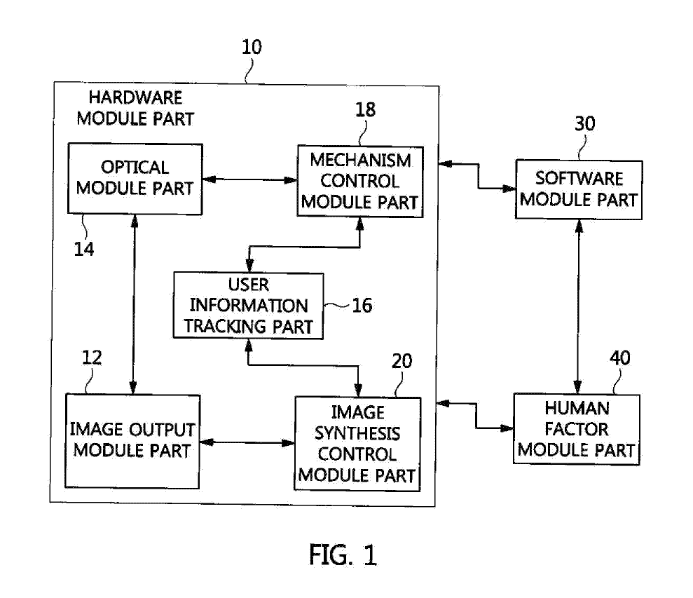

FIG. 1 is a block diagram of a human factor-based wearable display apparatus according to an embodiment of the present invention.

A human factor-based wearable display apparatus according to an embodiment of the present invention includes a hardware module part 10, a software module part 30, and a human factor module part 40.

The hardware module part 10 includes an image output module part 12, an optical module part 14, a user information tracking part 16, a mechanism control module part 18, and an image synthesis control module part 20.

The image output module part 12 outputs images.

The optical module part 14 enlarges a small image, output from the image output module part 12, to the maximum size.

The user information tracking unit 16 obtains user characteristic information in real time in order to generate an image and to implement interaction functions. Here, the user characteristic information may include the relative positions of the two eyeballs (IPD) and posture information (that is, the view vector of an eyeball, including pitch, yaw, and roll). “IPD” stands for “inter-pupil distance”, which is a physical characteristic of a user.

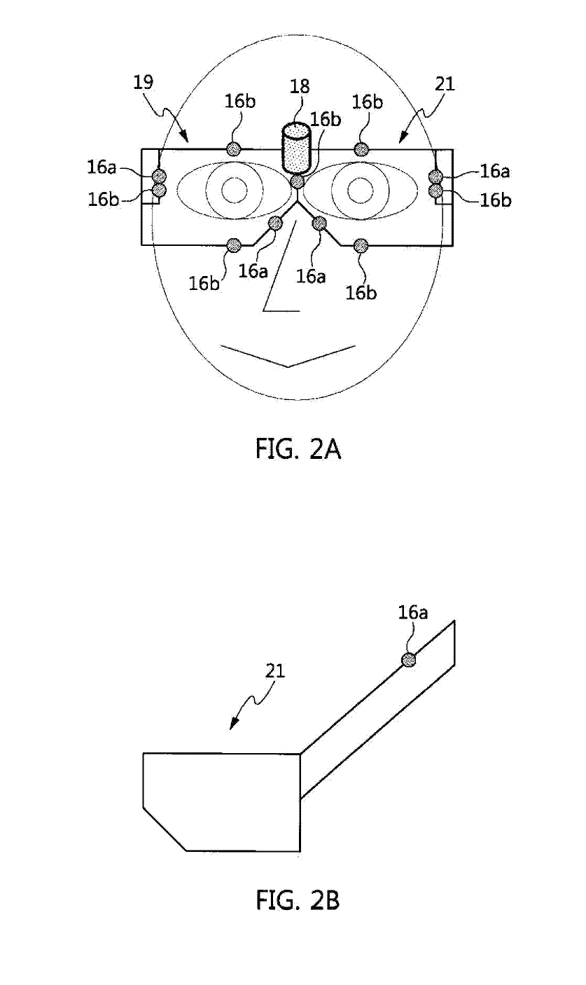

The mechanism control module part 18 changes the spatial arrangement position and posture of mechanism parts (wearing part) (19 and 21 in FIG. 2A) that affect the vision of a user based on the information from the user information tracking part 16. Here, the mechanism parts 19 and 21 are components in which a device module capable of providing virtual images and actual images to the user eyes is installed. All or part of the hardware module part 10 of FIG. 1 may be installed in the mechanism parts 19 and 21.

The image synthesis control module part 20 generates the input data of a final output image, that is input image data, based on the information from the user information tracking unit 16. The image synthesis control module part 20 transmits the generated input image data to the image output module part 12.

Based on static hardware parameters (values that are fixed in the manufacturing step), the software module part 30 simulates and generates virtual environment information that reflects the information of the mechanism control module part 18, the information of the user information tracking part 16, and the information of the image synthesis control module part 20, the information of the modules being updated in real time. Here, “generation” means, for example, adjusting the control parameters of a virtual camera to the hardware configuration values in the computer graphic rendering process.

Through statistical experiments on actual users, the human factor module part 40 stores characteristics related to humans' recognition of information (2D and 3D images) provided by the wearable display apparatus (for example, one or more human factors for recognizing 3D images). Also, the human factor module part 40 has a function of correcting the difference between a theoretical computer simulation model and a model recognized through the actual use of the apparatus.

Consequently, the present invention intends to accurately detect where the eyes of a person are looking.

FIGS. 2A and 2B illustrate embodiments of the mechanism control module part 18 and the user information tracking part 16, illustrated in FIG. 1, and show the configuration of the sensor and mechanism part of a wearable display apparatus, which may present a stereoscopic image optimized for a user by extracting the information of the user (the above-mentioned user characteristic information). FIG. 2A exemplifies a center frame when the wearable display apparatus takes the form of glasses, and FIG. 2B exemplifies the earpiece of the glasses.

Because a general wearable display apparatus, which presents a 3D stereoscopic image using binocular disparity information, designs the size of the exit pupil (the range in which the image generated by the wearable display apparatus is completely seen by the eyes of a user), one of the optical system design parameters, to be sufficiently large, the IPD, which is a personalized parameter, may not be reflected in the hardware of the apparatus.

However, the present invention implements a function for IPD, and thus provides a method in which a higher level of individual optimization is possible. FIG. 1 shows the reciprocal relationship between the hardware module part 10, the software module part 30, and the human factor module part 40 for an ideal wearable display apparatus. According to the reciprocal relationship, the mechanism control module part 18 may change the 6 degrees of freedom (position and posture) of the left and right mechanism parts 19 and 21 in FIG. 2A.

In FIGS. 2A and 2B, in order to track the view vector (pitch, yaw, and roll) of the user's eyes, Electro Oculography (EOG) sensors 16a and image sensors 16b are arranged in places on the wearable display apparatus.

In FIGS. 2A and 2B, the multiple EOG sensors 16a may measure the movement of ocular muscles. Because the EOG sensor 16a may obtain the electric potential difference information of the ocular muscles, which is generated by the movement of eyeballs, the direction of the movement of the eyeballs may be determined by the pattern of values extracted by the multiple EOG sensors 16a (a detailed description thereof is omitted since this is an already known eye tracking technique).

Also, the present invention arranges multiple image sensors 16b around the eyeballs to compensate for the disadvantages of the EOG sensor 16a (namely, noise, such as vibrations, and low accuracy).

An eye tracking technique using the image sensor 16b also has disadvantages caused by eye blinking. Therefore, the combination of the two information extracting methods may mutually compensate for the disadvantages of each method, and may improve the accuracy of the information about the movement of eyeballs.

Meanwhile, in FIGS. 2A and 2B, because the EOG sensor 16a is required to contact the skin, it is desirable to dispose the EOG sensor to be in contact with the user's skin on the nose (in the middle of the forehead) and between the temple and the ear.

Also, in FIGS. 2A and 2B, it is desirable to arrange the image sensor 16b in 360 degrees around the wearable display apparatus (for example, around the rims of glasses) to observe the eyeballs.

The user information tracking part 16 may include the above-mentioned multiple EOG sensors 16a and multiple image sensors 16b.

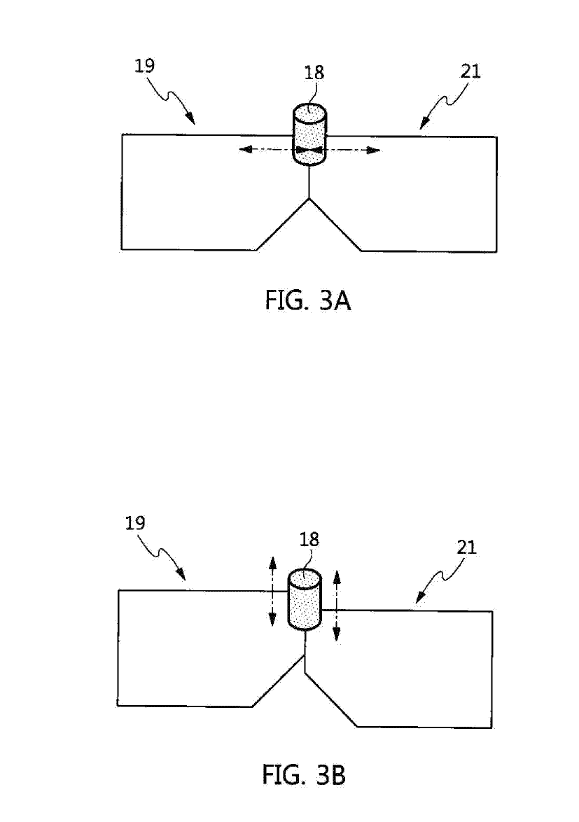

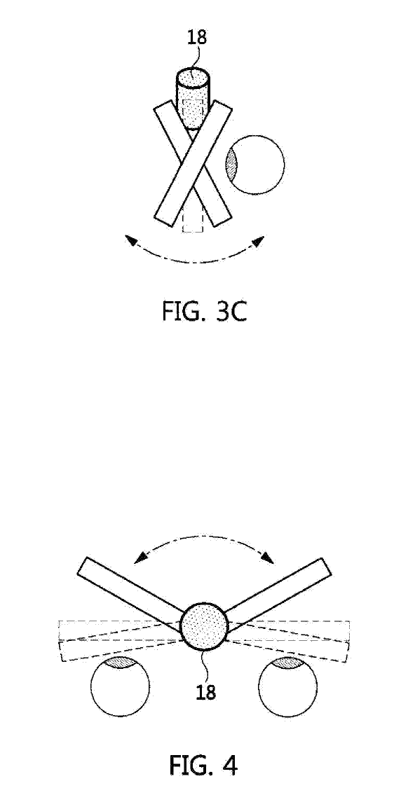

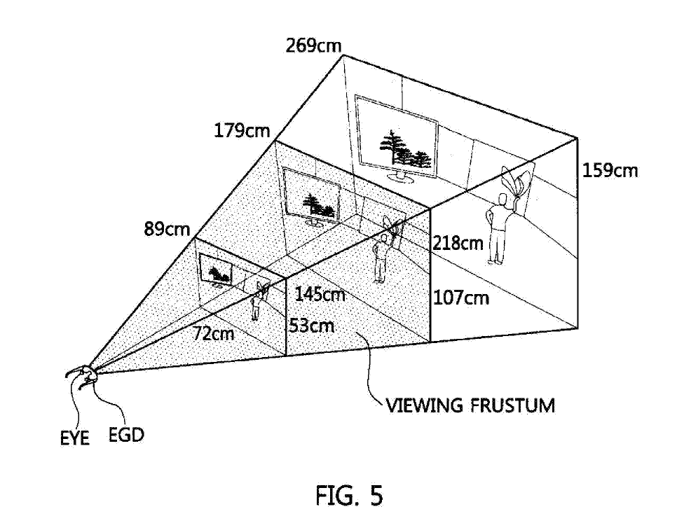

FIGS. 3A, 3B, and 3C illustrate examples in which 6 degrees of freedom of a binocular module are changed by the mechanism control module part 18 of FIG. 1, FIG. 4 illustrates an example in which the convergence of the binocular module is changed by the mechanism control module part 18 of FIG. 1, and FIG. 5 illustrates an example in which the focus of the binocular module is changed by the mechanism control module part of FIG. 1.

In FIGS. 3A, 3B, and 3C, the mechanism control module part 18 includes a control adjustment unit (not illustrated) that may change the 6 degrees of freedom (X, Y, and Z positions, and pitch, yaw, and roll postures) of the left and right mechanism parts 19 and 21 to reflect various physical characteristics of the user (for example, the distance between two eyes, the degree of symmetry, and the relative positions). The part represented by the reference numeral 18 may be the control adjustment unit, but in this embodiment the control adjustment unit is assumed to be included in the mechanism control module part 18 for convenience of description.

In human visual sensation, convergence occurs, namely, the eyeballs of the two eyes turn inward to focus on objects closer than about 1 m. Accordingly, when the sense of distance is represented in 3D, the mechanism control module part 18 turns the binocular modules to the center to focus on nearby objects, as shown in FIG. 4. Conversely, when the eyes are viewing a faraway object, the lines of sight become nearly parallel, thus the mechanism control part 18 turns the binocular modules to the corresponding angle. Here, the turning of the mechanism control module part 18 may be controlled manually, or may be controlled automatically by adding an actuator such as a motor. The convergence of human factors may be applied by the above-mentioned method, and the IPD of human factors may be applied by changing the horizontal distance between visualization modules as shown in FIG. 4.

In order to apply focus (visual accommodation; distance control by changing the thickness of an eye lens), one of the human factors, to the wearable display apparatus, the left and right optical module parts 14 may be embodied by a component having variable focus, as shown in FIG. 5. For example, a component in the form of a liquid lens or an optical component made of polymer, of which the curved surface or the thickness is changed by an electrical impulse, may be used The final value, changed for optimization in the above-mentioned step, is stored in the digitalized storage of the mechanism control module part 18, and is transmitted in response to a request from the software module part 30 in order to apply the accurate parameter values for a current hardware model to a simulation for generating a virtual image.

Also, because the wearable display apparatus of the present invention has a structure that may be changed for individual optimization, the software module part 30 records the optimized configuration information of hardware along with the personal information of the wearer (for example, user ID), and may apply the information when data is restored and the hardware module part 10 of the wearable display apparatus is optimized in response to a request.

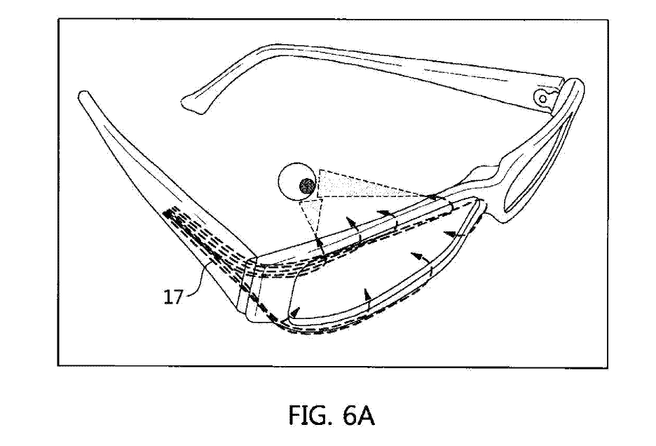

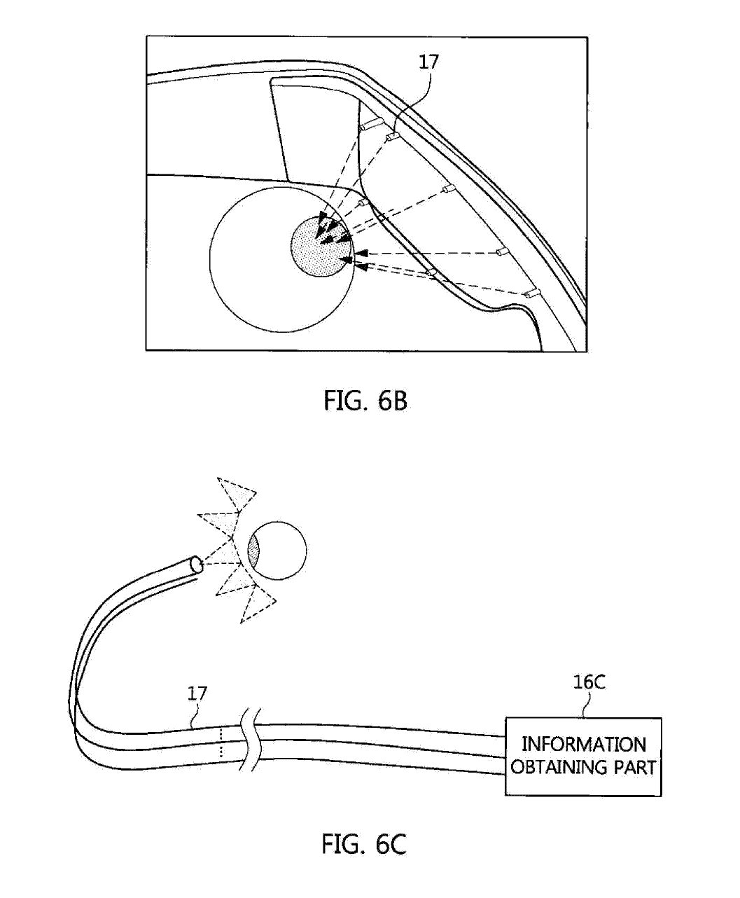

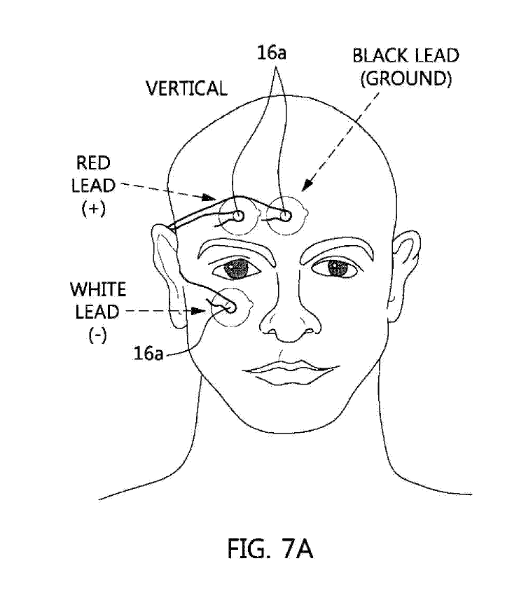

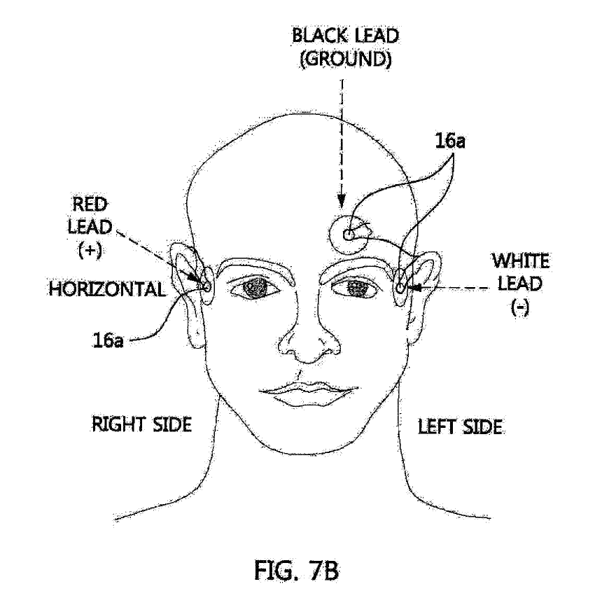

FIGS. 6A, 6B, and 6C illustrate an example in which an image sensor is differently installed, and FIGS. 7A and 7B illustrate an example in which an EOG sensor is differently installed.

Comparing the image sensor 17 of FIGS. 6A, 6B, and 6C with the image sensor 16b of FIG. 2A, the multiple image sensors are separately installed in various places on the wearable display apparatus (for example, the glasses) in FIG. 2A, whereas the image sensor 17 of FIGS. 6A, 6B, and 6C has a form in which one ends of multiple optical fibers are bound and the other ends of the multiple fibers are separately disposed around the center frame of the wearable display apparatus. Here, the optical fiber is described by way of example, but anything capable of transmitting the image of the image sensor 17 can be used Also, the information obtaining part 16c of FIG. 6C may make a large image by merging small images from each of the image sensors 17, as if the pieces of a puzzle were put together.

Among the wearer's information, the relative position of the two eyeballs (IPD) and the values related to a posture (the view vector of eyeballs) may be acquired based on the data obtained from each of the image sensors 17. Because 3-dimensional structure information for the wearable display apparatus and the arrangement of sensors are determined in a CAD drawing during the apparatus manufacturing process, and information concerning the change of the mechanism control module part 18 is digitally tracked, the reference position may be easily acquired. If necessary, a camera calibration technique of 3D computer vision technology may be used to restore the relative position of each of the sensors in 3-dimensional space. When the positions of multiple image sensors 17 disposed around both eyes are determined as described above, if the position of the center of each of the eyeballs (i.e. the pupil) is calculated, accurate values of the IPD parameter, one of the human factors, may be extracted.

When the embodiment of FIGS. 2A and 2B is applied to the configuration of FIG. 1, a vision-based eye tracker using a general camera module may be used as an image sensor 16b. However, a conventional eye tracker technique based on a single image sensor obtains the image of a target (eyeball) in a limited field of view, and thus only the information of a limited area is extracted. Also, there are disadvantages in that the size of the sensor must be larger in order to obtain more data and in that both the volume and the weight of the single sensor module are increased by adding an optical module (lens) for obtaining images. Conversely, according to the distributed arrangement of sensors, illustrated in FIGS. 6A, 6B, and 6C, although the size and weight of each of the image sensors are reduced and each of the sensors has low resolution, it is possible to implement an image sensing technology based on multi-channel imaging because multiple sensors are disposed around the eyeballs. Also, because image data is obtained in 360 degrees around the eyeballs through the structure of FIGS. 6A, 6B, and 6C, more stable and precise information about the user (eyeball) may be obtained than when using the conventional technique.

The number and positions of the unit image sensors of FIG. 2A are an example, and a plurality of unit sensor modules may be embedded in the frame of a wearable display apparatus. The unit image sensor of FIGS. 6A, 6B, and 6C is intended to avoid increasing the volume and weight of the wearing part, which may be caused by the implementation method of FIGS. 2A and 2B. The example of FIGS. 6A, 6B, and 6C may be understood as an application of the structure of a micro-endoscope. Specifically, using fiber optic cables about 10 μm in diameter and an image obtaining lens processing unit at the end of the fiber optic cables, the fiber optic cables are arranged in the frame around the eyeballs, the fiber optic cables are extended to suitable positions (the side of the head, the back of the head, a helmet, or a separate control module) to distribute the weight of the wearable display apparatus, and a multi-channel image sensor module is connected to the fiber optic cables. Accordingly, the above-mentioned problem may be solved. In this case, the field of view of an image obtained by a single image sensor is narrow. However, because the multi-channel image sensor module is connected, it is possible to obtain the user information (eyeball) corresponding to the desired view in a range of 360 degrees.

Also, an example of the attachment of an EOG sensor 16a, illustrated in FIGS. 7A and 7B (http://elte.prompt.hu/sites/default/files/tananyagok/PhysiologyPractical/ch09s06.html) shows the case in which adhesive sensors are attached to the skin for research into eyeball-tracking and the like. However, this method has low usability for general users. Therefore, the present invention proposes a method in which an EOG sensor 16a is embedded only in the parts that contact a user's skin in the wearable display apparatus, as shown in FIGS. 2A and 2B. The data obtained through this method may be relatively inaccurate, but if a pattern recognition module is implemented by a hybrid algorithm with the multi-channel image sensor information described above, it is possible to implement a stable user (eyeball) information tracking function based on the EOG sensor 16a and the image sensor 16b.

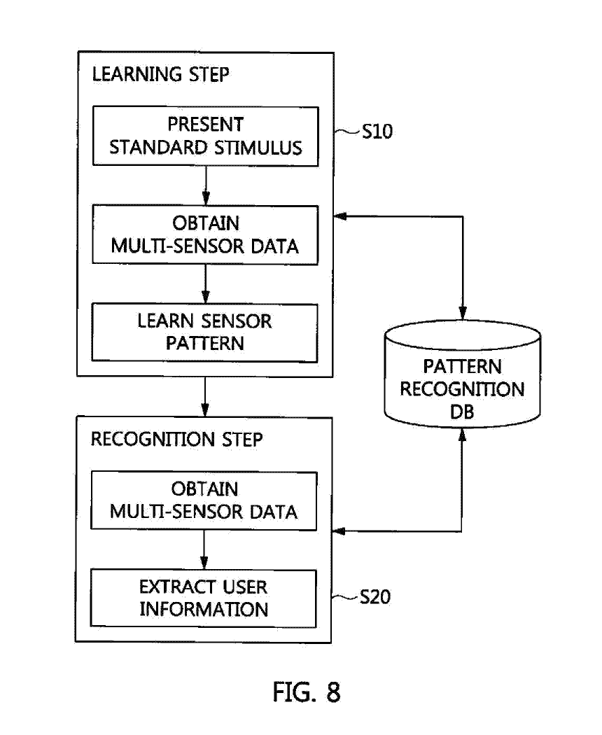

FIG. 8 is a view explaining a user information extraction operation in the user information tracking part 16 illustrated in FIG. 1. That is, FIG. 8 shows a flowchart of an embodiment in which a general decision making step based on pattern recognition is described according to the technique proposed by the present invention.

First, a recognition step S20 is performed after a learning step S10.

Specifically, when a standard stimulus is presented to the user's eyeballs at the learning step S10, the eyeballs respond to the stimulus. Accordingly, the relationship between a standard input sample depending on the movement of the eyeballs and values obtained from multiple image sensors 16b and the multiple EOG sensors 16a is patterned based on a pattern recognition DB, and learning is performed.

Then, at the recognition step S20, user information is extracted based on the values obtained from the multiple image sensors 16b and the multiple EOG sensors 16a.

Through this process, the movement of the eyeballs of various users may be recognized and tracked.

As an example to which the above-described technique of the present invention is applied, there may be a multi-display environment in which heterogeneous display devices such as 2D/3D TVs, 2D/3D screens, smart pads, smart phones, and the like are mixed. Also, there may be a scenario in which virtual information is searched for, generated, and produced based on a wearable display apparatus in a mobile augmented/mixed reality environment.

The present invention configured as described above has the following effects.

When a human recognizes a stereoscopic image in 3D space, various factors are changed in an ocular organ, but an existing 3D stereoscopic image display technology outputs an image using a fixed hardware structure to which individual user characteristics are not applied. As a result, adverse effects related to human factors for the 3D stereoscopic image display have been reported, and these may be obstacles to the expansion of markets for 3D stereoscopic image displays. The present invention proposes a hardware structure for recognizing various characteristics of user's ocular organs, and operates software in conjunction with human factors, whereby problems in the existing 3D stereo image display industry may be solved.

In the case of existing virtual, augmented, and mixed reality technology (for example, interactive games of Microsoft XBOX and Nintendo Wii), although a user interacts with the apparatus in near-body space, the effect is generated at a long range. However, the present invention may realistically apply the virtual reality technology to various experiences generated by physical activities within a range of 1 m from a user (near-body space).

As described above, optimal embodiments of the present invention have been disclosed in the drawings and the specification. Although specific terms have been used in the present specification, these are merely intended to describe the present invention, and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A human factor-based wearable display apparatus, comprising:
a hardware module part comprising a user information tracking part for obtaining characteristic information of a user who wears the wearable display apparatus;
a software module part for simulating and generating virtual environment information based on static hardware parameters, input image data, and the information of the user information tracking part; and
a human factor module part for correcting a difference between a simulation model in the software module part and a model recognized through actual use of the apparatus.

2. The human factor-based wearable display apparatus of claim 1, wherein the hardware module part further comprises a mechanism control module part for changing a spatial arrangement position and posture of a mechanism part of the wearable display apparatus, and
the software module part simulates the virtual environment information based on information of the mechanism control module part.

3. The human factor-based wearable display apparatus of claim 1, wherein the characteristic information of the user includes information about a relative position and posture information of both eyeballs of the user.

4. The human factor-based wearable display apparatus of claim 3, wherein the information about the relative position is an inter pupil distance of the user.

5. The human factor-based wearable display apparatus of claim 3, wherein the posture information includes a view vector.

6. The human factor-based wearable display apparatus of claim 2, wherein the user information tracking part comprises multiple image sensors and multiple EOG sensors, performs learning by patterning a relationship between a standard input sample depending on movement of eyeballs and values obtained from the multiple image sensors and multiple EOG sensors, and performs user information tracking based on the values obtained from the multiple image sensors and multiple EOG sensors.

7. The human factor-based wearable display apparatus of claim 1, wherein the software module part records optimized hardware configuration state information along with personal information of the user and applies the information to optimize the hardware module part.

8. The human factor-based wearable display apparatus of claim 1, wherein the hardware module part further comprises an optical module part having a variable focus function.

9. The human factor-based wearable display apparatus of claim 8, wherein the hardware module part further comprises an image output module part for outputting an input image to the optical module part.

10. The human factor-based wearable display apparatus of claim 9, wherein the hardware module part further comprises an image synthesis control module part for transmitting input image data to the image output module part, based on the information from the user information tracking part.

11. The human factor-based wearable display apparatus of claim 1, wherein the human factor module part stores a human recognition characteristic related to information presented by the wearable display apparatus.

12. The human factor-based wearable display apparatus of claim 11, wherein the human recognition characteristic comprises one or more human factors for recognizing a 3D image.

13. A human factor-based wearable display apparatus, comprising:
a hardware module part comprising a mechanism control module part for changing a spatial arrangement position and posture of a mechanism part of the wearable display apparatus;
a software module part for simulating and generating virtual environment information based on static hardware parameters, input image data, and the information of the user information tracking part; and
a human factor module part for correcting a difference between a simulation model in the software module part and a model recognized through actual use of the apparatus.

14. The human factor-based wearable display apparatus of claim 13, wherein the mechanism control module part changes 6 degrees of freedom of the mechanism part of the wearable display apparatus based on a value obtained from a user information tracking part.

15. The human factor-based wearable display apparatus of claim 13, wherein the hardware module part further comprises an optical module part having a variable focus function.

16. The human factor-based wearable display apparatus of claim 15, wherein the hardware module part further comprises an image output module part for outputting an input image to the optical module part.

17. A user information tracking device of a wearable display apparatus, comprising:
multiple image sensors; and
multiple EOG sensors,
wherein the image sensors and the EOG sensors are used for patterning and learning a relationship of standard input samples depending on movement of eyeballs, and for tracking user information.

18. The user information tracking device of claim 17, wherein the image sensors are disposed at a periphery in a mechanism part of the wearable display apparatus, the periphery being opposite to eyeballs of a user.

19. The user information tracking device of claim 17, wherein the EOG sensors are disposed in a mechanism part of the wearable display apparatus so as to contact a user's skin on a nose and between a temple and an ear.

20. The user information tracking device of claim 17, wherein the image sensors are manufactured based on a principle of a micro-endoscope, and are disposed at a periphery in a mechanism part of the wearable display apparatus, the periphery being opposite to eyeballs of a user.
